(19) United States
(12) Patent Application Publication
(10) Pub. No.: US 2006/0121165 A1
(43) Pub. Date: Jun. 8, 2006

(54) Food freshness sensor

(76) Inventor: Roger J. Morris, Vero Beach, FL (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 11/295,136

(22) Filed: Dec. 6, 2005

Related U.S. Application Data
(63) Continuation-in-part of application No. 10/659,222, filed on Sep. 10, 2003.
(63) Continuation-in-part of application No. 10/799,312, filed on Mar. 12, 2004.
(60) Provisional application No. 60/633,750, filed on Dec. 7, 2004.
(60) Provisional application No. 60/411,068, filed on Sep. 16, 2002.
(60) Provisional application No. 60/421,699, filed on Oct. 28, 2002.
(60) Provisional application No. 60/484,869, filed on Jul. 3, 2003.

(51) Int. Cl. A23G 3/28

(52) U.S. Cl. 426/383

(57) ABSTRACT

A sensor for detecting a presence of bacteria in a perishable food includes a pH sensitive solution of bromothymol blue and methyl red mixed with an alkaline resulting in a pH value and a generally green color changing to a generally orange color responsive to exposure to a concentration of carbon dioxide. The solution is packaged in a gas permeable container using a TPX (PMP) thin film that allows an effective diffusion of carbon dioxide through the container. The pH level drops when acidic carbon dioxide comes into contact with the solution resulting from a formation of carbonic acid, making the solution an indicator of carbon dioxide concentration, and thus an indication of bacterial growth.

### CROSS-REFERENCE TO RELATED APPLICATIONS

This application claims the benefit of U.S. Provisional Application No. 60/633,750 filed Dec. 7, 2004 for “Food Freshness Sensor,” and is a Continuation-in-Part of application Ser. No. 10/659,222 filed Sep. 10, 2003 for “Food-Borne Pathogen and Spoilage Detection Device and Method,” and Ser. No. 10/799,312 for “Food Borne Pathogen Sensor and Method,” filed on Mar. 12, 2004, both of which have a priority claim to U.S. Provisional Patent Application Nos. 60/411,068 filed on Sep. 16, 2002, 60/421,699 filed on Oct. 28, 2002, and 60/484,869 filed on Jul. 3, 2003, the disclosures of which are hereby incorporated by reference herein in their entirety, and all commonly owned.

### FIELD OF INVENTION

The present invention generally relates to pathogen detection devices and methods, and, in particular, to devices and methods for detecting food-borne pathogens and spoilage.

### BACKGROUND

Food borne diseases as well as food spoilage remain a significant burden in the global food supply. In the U.S. alone there are 76 million cases of food-borne illnesses annually, which is equivalent to one in every four Americans, leading to approximately 325,000 hospitalizations and over 5000 deaths annually. According to the United States Government Accounting Office (GAO) and United States Department of Agriculture (USDA), food-borne pathogens cause economic losses ranging from $7 billion to $37 billion dollars in health care and productivity losses. Hazard Analysis and Critical Control Point (HACCP) regulations state that a hazard analysis on a food product must include food-safety analyses that occur before, during, and after entry into an establishment. There is a clear need to ensure that food transported from the processor to the consumer is as safe as possible prior to consumption. For example, the development of antibiotic resistance in food borne pathogens, the presence of potential toxins, and the use of growth hormones, all indicate a need for further development of HACCP procedures to ensure that safer food products are delivered to the consumer. There is also a need to monitor foods being handled by a consumer even after such food is purchased, partially used, and stored for future use.

Meat, for example, is randomly sampled at a processor for food borne pathogens. Generally, no further testing occurs before the meat is consumed, leaving the possibility of unacceptable levels of undetected food-borne pathogens, such as Salmonella spp. and Listeria spp., as well as spoilage bacteria, such as Pseudomonas spp. and Micrococcus spp. being able to multiply to an undesirable level during the packaging, transportation, and display of the product. Subsequently, the food product may be purchased by the consumer, transported, and stored in uncontrolled conditions that only serve to exacerbate the situation, all these events occurring prior to consumption.

Retailers generally estimate shelf life and thus freshness with a date stamp. This method is inaccurate for at least two reasons: first, the actual number of bacteria on the meat at the processor is typically unknown, and second, the actual time-temperature environment of the package during its shipment to the retailer is typically unknown. As an example, a temperature increase of less than 3° C. can shorten food shelf life by 50% and cause a significant increase in bacterial growth over time. Indeed, spoilage of food may occur in as little as several hours at 37° C. based on the universally accepted value of a total pathogenic and non-pathogenic bacterial load equal to 1×10⁷ cfu/gram or less on food products. Food safety leaders have identified this level as the maximum acceptable threshold for meat products.

While many shelf-life-sensitive food products are typically processed and packaged at a central location, this has not been typical for the meat industry. The recent advent of centralized case-ready packaging as well as “cryovac” packaging for meat products offer an opportunity for the large-scale incorporation of sensors that detect both freshness and the presence of bacteria.

A number of devices are known that have attempted to provide a diagnostic test that reflects either bacterial load or food freshness, including time-temperature indicator devices. To date, none of these devices has been widely accepted either in the consumer or retail marketplace, for reasons that are specific to the technology being applied. First, time-temperature devices only provide information about integrated temperature history, not about bacterial growth. Thus it is possible, through other means of contamination, to have a high bacterial load on food even though the temperature has been maintained correctly. Wrapping film devices typically require actual contact with the bacteria. If the bacteria are internal to the exterior food surface, then an internally high bacterial load on the food does not activate the sensor. Ammonia sensors typically detect protein breakdown and not carbohydrate breakdown. Since bacteria initially utilize carbohydrates, these sensors typically have a low sensitivity in most good applications, with the exception of seafood.

Further, known devices and methods for detecting bacteria in food substances typically integrally incorporate the device in to a package at manufacture. Neither the provider nor the consumer is able to continue the monitoring with a repackaging of the food product. It is desirable to provide a device, food packaging, and associated methods for detecting at least a presence of bacteria in a perishable food product. Further, it is desirable for a consumer to be able to detect a presence of bacteria throughout the handling of the food product by the consumer.

### SUMMARY OF THE INVENTION

The present invention may be directed to detecting at least a presence of bacteria in a perishable food product carried within a container or package prepared by a supplier of the food product or by a consumer handling the food product after purchase. Embodiments of the invention may provide a quantitative measure of bacterial load and detect the presence of bacteria in or on the food product. In addition, a sensor according to the teachings of the present invention may be safely consumed if mistakenly eaten.

One sensor for detecting a presence of bacteria in a perishable food may include a pH sensitive solution of bromothymol blue and methyl red mixed with an alkaline solution, by way of example, resulting in a pH value and a generally green color changing to a generally orange color responsive to exposure to a concentration of carbon dioxide. The solution is packaged in a gas permeable container using a TPX (PMP) thin film that allows an effective diffusion of carbon dioxide through the container. The pH level drops when acidic carbon dioxide comes into contact with the solution resulting from a formation of carbonic acid making the solution an indicator of carbon dioxide concentration and thus bacterial growth.

Another embodiment may include a sensor for detecting a presence of bacteria from a perishable food product, wherein the sensor may include a sealed container having a gas permeable wall formed from a TPX (PMP) thin film and a transparent portion for viewing its contents. A pH sensitive solution is carried within the container and may have a generally green color changing to a generally orange color responsive to a 0.5% concentration of an acidic gas generated outside the container in a bacteria detection range between one million and ten million bacteria. The pH sensitive solution may be carried between first and second gas-permeable wall portions of the container for permitting a desirable diffusion of the carbon dioxide between the wall portions.

A sensor may also include a pH sensitive mixture carried within a container with the mixture including bromothymol blue and methyl red mixed with an alkaline resulting in a pH value between 6 and 8. Yet further, the sensor may include the pH sensitive mixture of bromothymol blue and methyl red mixed with an alkaline resulting in a generally green color changing to a generally orange color responsive to exposure to a 0.5% concentration of an acidic gas, wherein the bromothymol blue comprises a % wt/volume between 0.02 and 0.08, the methyl red comprises a % wt/volume between 0.001 and 0.005, dissolved in an alkaline amount ranging between 0.5 mM and 1.5 mM.

One embodiment of the invention may comprise an aqueous pH indicator in a gas permeable envelope such that CO2 gas (produced by bacteria as they grow) diffuses into the container and reacts with the solution to reduce the pH:
CO₂+H₂O⇄H₂CO₃⇄H⁺+CO₃^{- -}

As the pH of the aqueous solution drops, due to the formation of carbonic acid, the pH indicator changes color thereby providing a visual indication of the drop in pH and therefore the presence of bacteria.

Extensive research and development has resulted in a desirable format for one embodiment of the invention including a sensor. In order to maximize the diffusion of carbon dioxide into the sensor, a two-sided design was selected that permits diffusion of gas from both sides of the sensor. This permits a rapid color change that minimizes the time a sensor is in an “uncertain zone,” where color changes are gradual and not produced in a step-styled change as is the case for embodiments of the present invention. To further improve free diffusion of gas to both sides of the sensor, it may also be desirable to place the sensor in a spaced relation to a wall of a food package in which the food product is carried.

Each component was selected and optimized to achieve the highest performance and longest shelf life at the lowest cost to manufacture. The sensor may comprise:
1. pH indicators and an initial pH of the sensor solution;
2. A thin permeable film to enclose the solution; and
3. Manufacture of the sensor through a sealing of the solution between two layers of the film.

### BRIEF DESCRIPTION OF THE DRAWINGS

Features and benefits of the present invention will become apparent as the description proceeds when taken in conjunction with the accompanying drawings in which:

FIG. 1 is a diagrammatical cross section view of embodiments of the invention useful in detecting spoiling of a food product;

FIG. 2 is a partial cross sectional view of one embodiment of a sensor in keeping with the teachings of et present invention;

FIG. 3 includes a spectrum (360-720 nm) of a solution of a pH formulation at room temperature at day one (hashed plot) and day sixty (solid plot) reflecting excellent shelf life of the formulation; and

FIG. 4 is a table illustrating an effect of incubation of skinless chicken that had been cooked or was raw then stored at 10° C. on biochemical and microbiological parameters.

### DETAILED DESCRIPTION OF THE PREFERRED EMBODIMENTS

The present invention will now be described more fully hereinafter with reference to the accompanying drawings, in which embodiments of the invention are described. This invention may, however, be embodied in many different forms and should not be construed to be limited to the embodiments set forth herein. Rather, these embodiments are provided so that this disclosure will be thorough and complete, and fully convey the scope of the invention to those skilled in the art. Like numbers refer to like elements throughout.

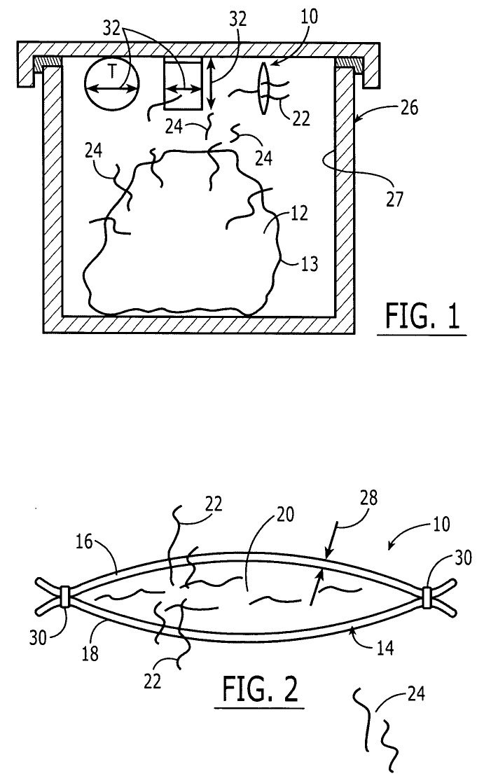

Referring initially to FIGS. 1 and 2, and by way of example, a sensor 10 in keeping with the teachings of the present invention for detecting a presence of bacteria from a perishable food product 12 includes a sealed container 14 having opposing gas permeable walls 16, 18 formed from a TPX (PMP) transparent thin film for viewing a pH sensitive solution 20 carried by the container 14. For one embodiment, the pH sensitive solution 20 has a generally green color changing to a generally orange color responsive to a 0.5% concentration of an acidic gas generated outside the container 14 by a spoiling of the food product 12 for a bacteria detection range between one million and ten million bacteria. With continued reference to FIGS. 1 and 2, the pH sensitive solution 20 is carried between the opposing walls 16, 18 of the container for permitting desirable gas diffusion 22 of carbon dioxide gas 24 emitted from the food product 12 to pass through the container 14 and solution 20. While not required, it is expected that the sensor 10 may be placed in a package 26 with the food product 12 being monitored. As above described, in order to maximize the diffusion of the carbon dioxide gas 24 into the sensor 10, a two-sided design was selected that permits diffusion of gas from both sides of the sensor. This permits a rapid color change that minimizes the time a sensor is in an “uncertain zone,” where color changes are gradual and not produced in a step-styled change as is the case for embodiments of the present invention. To further improve free diffusion of gas to both sides of the sensor 10, it may also be desirable to place the sensor in a spaced relation to walls 27 of the package 26 carrying the food product 12 or surfaces 13 of the food package itself, as illustrated with reference again to FIG. 1.

As herein described by way of example for one embodiment of the invention, carbon dioxide is used as a generic indicator of bacterial growth and for quantitatively estimating a level of bacterial contamination present in the food product 12. As is well known, when carbon dioxide comes into contact with a solution, the pH drops as a result of a formation of carbonic acid, making a pH value an indicator of carbon dioxide concentration and thus of a bacterial load.

For embodiments of the invention as herein described, the sensor 10 includes the solution 20 having a pH value between 6 and 8. Further, an embodiment includes the pH sensitive solution having bromothymol blue and methyl red mixed with an alkaline solution of sodium hydroxide. One embodiment includes the bromothymol blue in a 0.05% wt/volume and the methyl red in a 0.0035 wt/volume dissolved in 1 mM sodium hydroxide for providing a pH value of approximately 6.8. By way of example, test results have resulted in effective solutions 20 with the bromothymol blue having a % wt/volume between 0.02 and 0.08, the methyl red having a %wt/volume between 0.001 and 0.005, dissolved in an alkaline solution of sodium hydroxide ranging between 0.5 mM and 1.5 mM for providing the pH value of the solution ranging between 6 and 8.

For the embodiment of the sensor 10 illustrated with reference again to FIG. 2, the walls 16, 18 are made from the thin film having a thickness dimension 28 of approximately 0.001 inches. As will come to the mind of those skilled in the art now having the benefit of the teachings of the present invention, an antifreeze agent such as ethylene glycol may be added to the solution 20 with an appropriate modification of the mixture to achieve the desired pH value. One embodiment for which test data is herein presented included a 1.4 mil thick transparent film with the TPX (PMP) film as opposing sheets sealed about a periphery 30. One embodiment included the container 14 having a dimension 32 of approximately one inch by one inch, as illustrated with reference again to FIG. 1. For the embodiments herein presented by way of example, heat was applied for sealing the periphery 26 of the opposing film sheets.

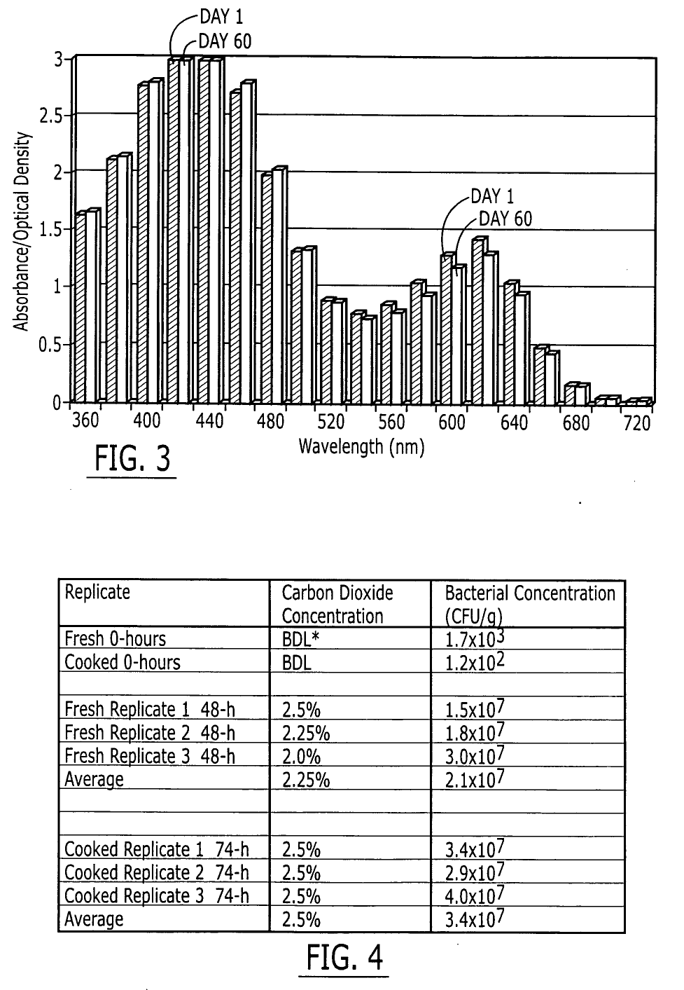

With regard to the solution 20, studies involved a pH range finding to yield a product with an initial color of rich green (similar to traffic light green) while also producing an orange-red color (typically accepted danger color) at a relevant microbial load. By way of example, while potentially useful for some situations, an initial formulation proved to be too sensitive and thus not desirable for a practical application of interest as a freshness detector (color change at 0.5% CO₂ and approximately 5×10⁵ CFU/g). One desirable embodiment including a formula containing 0.05% bromothymol blue, 0.003% methyl red dissolved in 1 mM NaOH provides a starting pH of 6.8 and yielded a green to orange color change occurring at a 0.5% CO2 concentration. Of course modifications to the formulation may be required for certain applications (e.g. antifreeze agents such as ethylene glycol may be added to the active formulation to prevent freezing at lower temperatures). Further, the Material Safety data Sheet (MSDS) of the chemicals used at the concentrations herein presented, by way of example, indicate that such formulations at the concentrations presented would not be harmful to a human if consumed in error. By way of example, and as illustrated with reference to the plot of FIG. 3, a spectrum (360-720 nm) of a solution 20 of a pH formulation at room temperature at day one (hashed plot) and day sixty (solid plot) resulted in an excellent shelf life for a desirable formulation.

With regard to the container 14, a wide variety of transparent thin films were available in the marketplace. However, requirements for a film that will hold the aqueous solution are very specific and a substantial regimen of research and experimentation into optimal material for the sensor was undertaken. Desirable requirements included features selected from: a high gas permeability; thin film available (<2/1000 inch); relatively high carbon dioxide gas permeability; a high transparency; high flexibility; a heat sealable material; high flexibility; unstained by the pH indicator formulation; and a relatively low cost for manufacturing.

After extensive evaluation, it was determined that a TPX film thickness of 1.4 one thousandths of an inch with a high transparency rating meets all the above criteria. One embodiment of the sensor 10, and as above described, includes the manufacture of a square sensor, by way of example, by cutting two squares of TPX 1.4 mil thick, transparent film 1″ square, placing one square on top of the other, using a pulsed heat sealer to seal three sides, adding 0.5 ml of formulation to the formed container 14, and sealing the final side. If leaks occur at the corner, double seals on each side will solve the leaking issue.

The sensor 10 is now ready for use and has stability for at least two months at room temperature and a predicted shelf life in excess of one year at refrigerated temperatures. Naturally many parameters described in the manufacturing process may be varied dependent of application such as shape, size, volume of indicator added. The method of sealing may be heat as described above alternatively glue or other bonding agent may be applied.

With reference to FIG. 4, a table illustrates data that reflect performance of the sensor manufactured, as above described. Bacterial concentration is presented in colony forming units per gram (CFU/g). By way of example, the sensor 10 described above reflects one embodiment of the invention for which data were collected. Cooked chicken was handled following cooking to introduce a microbial population to the surface. The cooked chicken required approximately 1.5-times more time to reach a high microbial load, but the sensor performance was good for both fresh and cooked chicken.

Many modifications and other embodiments of the invention will come to mind of one skilled in the art now having the benefit of the teachings presented in the foregoing descriptions. By way of example, this invention may also be applied to preparing a sensor responsive to ammonia with the color change being green to blue. Alternative pH indicators may be selected that would provide alternative color changes as the pH increased to the alkaline as a result of the formation of hydroxide ions. Therefore, it is understood that the invention is not to be limited to the specific embodiments disclosed, and that modifications and embodiments are intended to be included within the scope of claims supported by this disclosure.

That which is claimed is:

1. A sensor for detecting a presence of bacteria from a perishable food product, the sensor comprising:
a sealed container having a gas permeable wall formed from a TPX (PMP) thin film and a transparent portion for viewing contents carried therein;
a pH sensitive solution carried within the container, the pH sensitive solution having a generally green color changing to a generally orange color responsive to a 0.5% concentration of an acidic gas generated outside the container in a bacteria detection range between one million and ten million bacteria, wherein the pH sensitive solution is carried between first and second gas-permeable wall portions of the container for permitting diffusion of the carbon dioxide therebetween.

2. The sensor according to claim 1, wherein the acidic gas comprises carbon dioxide.

3. The sensor according to claim 1, wherein the pH sensitive solution comprises a pH value between 6 and 8.

4. The sensor according to claim 1, wherein the pH sensitive solution comprises bromothymol blue and methyl red mixed with an alkaline solution.

5. The sensor according to claim 4, wherein the alkaline solution comprises sodium hydroxide.

6. The sensor according to claim 4, wherein the bromothymol blue comprises 0.05% wt/volume and the methyl red comprises 0.0035 wt/volume dissolved in an alkaline solution of 1 mM sodium hydroxide for providing a pH value of approximately 6.8.

7. The sensor according to claim 4, wherein the bromothymol blue comprises a % wt/volume between 0.02 and 0.08, the methyl red comprises a % wt/volume between 0.001 and 0.005, dissolved in an alkaline solution ranging between 0.5 mM and 1.5 mM for providing a pH value of the solution ranging between 6 and 8.

8. The sensor according to claim 1, wherein the thin film comprises a thickness of 0.001 inches.

9. The sensor according to claim 1, further comprising an antifreeze agent.

10. The sensor according to claim 9, wherein the antifreeze agent comprises ethylene glycol.

11. The sensor according to claim 1, wherein the container is formed from a 1.4 mil thick transparent film.

12. The sensor according to claim 1, wherein the first and second wall portions are formed from the TPX (PMP) film as opposing sheets, and wherein the opposing sheets are sealed about a periphery thereof for sealing the pH sensitive solution within the container.

13. The sensor according to claim 12, wherein the container comprises a dimension of approximately one inch by one inch.

14. The sensor according to claim 12, wherein heat is applied for sealing the periphery of the opposing sheets.

15. A sensor for detecting a presence of bacteria from a perishable food product, the sensor comprising:
a container having a gas permeable wall; and
a pH sensitive mixture carried within the container, the pH sensitive mixture including bromothymol blue and methyl red mixed with an alkaline mixture resulting in a pH value between 6 and 8, the pH sensitive mixture having a generally green color changing to a generally orange color responsive to exposure to a 0.5% concentration of an acidic gas.

16. The sensor according to claim 15, wherein the gas permeable wall comprises a TPX (PMP) thin film.

17. The sensor according to claim 16, wherein the container comprises first and second opposing sheets of the TPX (PMP) thin film, and wherein the opposing sheets are sealed about a periphery thereof for securing the pH sensitive mixture therebetween.

18. The sensor according to claim 16 wherein the thin film comprises a thickness of approximately one mil.

19. The sensor according to claim 15, wherein the container comprises a transparent portion for viewing contents carried therein.

20. The sensor according to claim 15, wherein the acidic gas comprises carbon dioxide resulting from a bacteria range between one million and ten million bacteria.

21. The sensor according to claim 15, wherein the pH sensitive mixture is carried between first and second gas-permeable wall portions of the container for permitting diffusion of the carbon dioxide therebetween.

22. The sensor according to claim 15, wherein the alkaline mixture comprises sodium hydroxide solution.

23. The sensor according to claim 15, wherein the bromothymol blue comprises 0.05% wt/volume and the methyl red comprises 0.0035 wt/volume dissolved in 1 mM sodium hydroxide for providing a pH value of approximately 6.8.

24. The sensor according to claim 15, wherein the bromothymol blue comprises a % wt/volume between 0.02 and 0.08, the methyl red comprises a % wt/volume between 0.001 and 0.005, dissolved in an alkaline amount ranging between 0.5 mM and 1.5 mM for providing the pH value of the mixture.

25. A sensor for detecting a presence of bacteria, the sensor comprising a pH sensitive mixture including bromothymol blue and methyl red mixed with an alkaline resulting in a pH value between 6 and 8, the pH sensitive mixture having a generally green color changing to a generally orange color responsive to exposure to a 0.5% concentration of an acidic gas, wherein the bromothymol blue comprises a % wt/volume between 0.02 and 0.08, the methyl red comprises a % wt/volume between 0.001 and 0.005, dissolved in an alkaline mixture ranging between 0.5 mM and 1.5 mM.

26. The sensor according to claim 25, wherein the mixture is a solution carried in a gas permeable container comprising a TPX (PMP) thin film allowing diffusion of the acidic gas therethrough.

27. The sensor according to claim 26, wherein the container comprises first and second opposing sheets of the TPX (PMP) thin film, and wherein the opposing sheets are sealed about a periphery thereof for securing the pH sensitive mixture therebetween.

28. The sensor according to claim 25, wherein the alkaline mixture comprises a sodium hydroxide solution.

29. The sensor according to claim 25, wherein the bromothymol blue comprises 0.05% wt/volume and the methyl red comprises 0.0035 wt/volume dissolved in 1 mM sodium hydroxide for providing a pH value of approximately 6.8.

30. The sensor according to claim 25, whereon the acidic gas comprises carbon dioxide acting as a generic indicator of bacterial growth for estimating a level of bacterial contamination present in a perishable food product, the carbon dioxide contacting the mixture causing a drop in the pH drops, making the pH an indicator of carbon dioxide concentration and thus of a bacterial load.
